(19) United States
(12) Patent Application Publication
(10) Pub. No.: US 2006/0272088 A1
(43) Pub. Date: Dec. 7, 2006

(54) Shower head

(76) Inventor: Young Chul Choi, Incheon (KR)

Correspondence Address: IPLA P.A., 3580 WILSHIRE BLVD., 17TH FLOOR, LOS ANGELES, CA, 90010, US

(21) Appl. No.: 10/555,684

(22) PCT Filed: Aug. 4, 2004
(86) PCT No.: PCT/KR04/01966

§ 371 Date: Nov. 4, 2005

(30) Foreign Application Priority Data
Aug. 7, 2003 (KR) 2003-0025498

(51) Int. Cl. A47K 3/00

(52) U.S. Cl. 4/615

(57) ABSTRACT

The invention relates to a shower head wherein harmful bacteria may not be bred and water sterilization effect may be kept excellent so that skin trouble and so on may not be caused owing to harmful bacteria. According to an aspect of the invention, there is provided a shower head 30 which has water passage 10 therein and has a plurality of holes 15 at its front end and the base end of which is connected to a water line 4, wherein a porous silver foam 45 is positioned in the water passage 10, and wherein the water passing through the water passage 10 may be sterilized by the silver foam 45.

### FIELD OF THE INVENTION

The invention relates to a shower head, and more particularly, relates to a shower head wherein harmful bacteria may not be bred and water sterilization effect may be kept excellent so that skin trouble and so on may not be caused owing to harmful bacteria.

### BACKGROUND OF THE INVENTION

Generally, a shower head is the implement which has water passage therein and has a plurality of holes at its front end and the base end of which is connected to a water line. And, a user may grip the head and may shower the desired region of the body.

By the way, the prior shower head has a disadvantage that harmful bacteria may be bred in the water passage when it has been used relatively for a long time so that the skin of the user may be contacted to the harmful bacteria during shower and the user may be suffered from skin trouble owing to harmful bacteria. Particularly, in case of the user whose skin is relatively sensitive, he/she may be more easily suffered from itching symptom or various skin troubles and the like.

Accordingly, a sterilization implement like a sterilization filter is positioned at the water line positioned before the shower head. However, because the life span of the sterilization implement may not be maintained for a long time, the user should replace the sterilization implement so that it may cause inconvenience to the user and the management cost may be increased.

### DETAILED DESCRIPTION OF THE INVENTION

The invention is created to solve the above described problems and so the object of the intention is to provide a shower head wherein harmful bacteria may not be bred and water sterilization effect may be kept excellent so that skin trouble and so on may not be caused owing to harmful bacteria.

According to an aspect of the invention, there is provided a shower head 30 which has water passage 10 therein and has a plurality of holes 15 at its front end and the base end of which is connected to a water line 4;

wherein a porous silver foam 45 is positioned in the water passage 10;

and wherein the water passing though the water passage 10 may be sterilized by the silver foam 45.

According to another aspect of the invention, there is provided a shower head 30 which has water passage 10 therein and has a plurality of holes 15 at its front end and the base end of which is connected to a water line 4;

wherein a silver balls 55 is positioned in the water passage 10;

and wherein the water passing through the water passage 10 may be sterilized by the silver balls 55.

### BRIEF DESCRIPTION OF THE DRAWINGS

FIG. 1 is a dissembled prospective view of the invention.

FIG. 2 is a sectional view of one embodiment of the invention.

FIG. 3 is a sectional view of another embodiment of the invention.

### THE PREFERRED EMBODIMENT OF THE INVENTION

A preferred embodiment of the invention will be described in detail below by referring to the accompanying drawings.

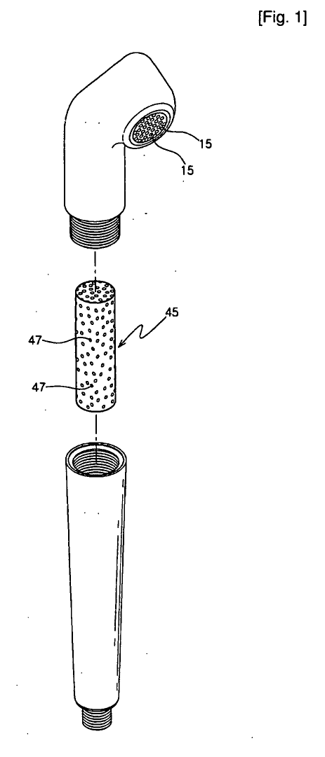

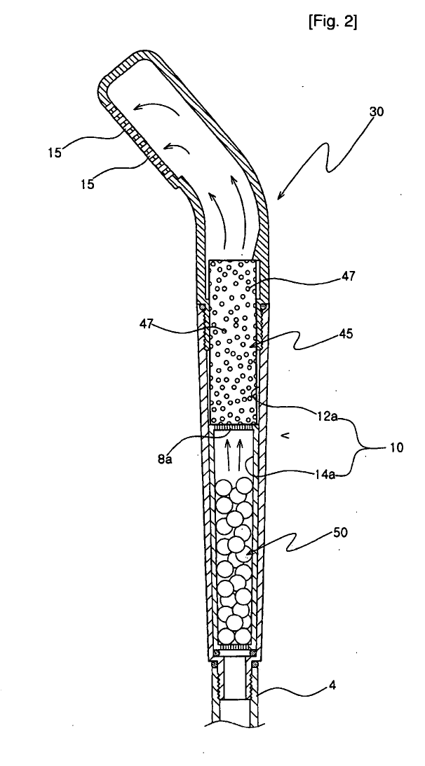

FIG. 1 is a dissembled prospective view of the invention, and FIG. 2 is a sectional view of one embodiment of the invention. Referring to the drawings, the invention has water passage 10 therein and has a plurality of holes 15 at its front end, and a silver foam 30 is positioned in the water passage 10.

The silver foam 45 is formed in a porous block like a resin sponge block and has a plurality of pores 47 though which the water may be passed. To make this silver foam 45, a porous resin sponge block such as polyurethane foam is treated by silver coating and the resin sponge is removed by incinerating the resin sponge, and then the porous pure silver foam 45 is acquired. The porous silver foam 45 is positioned in the water passage 10 of the head 30 so that it may sterilize the water passing through the water passage 10. And, silver is dissolved in the water from the silver foam 45 to generate Ag ion, which may sterilize the water. Particularly, the silver foam 45 is formed in a porous block type having a plurality of pores 47 and the water passes through the pores 47 of the silver foam 45 so that the contact area between silver and harmful bacteria or harmful alien material may be increased as much as possible. Accordingly, the water sterilization effect may be maximized because harmful bacteria or the alien material may be killed as much as possible. And, the silver foam 45 may be used almost eternally compared with a conventional sterilization filter so that there is no need replacing the silver foam 45 until the life span of the apparatus using the silver foam 30 has been expired. Accordingly, the invention is so convenient in use and may save the management cost.

Preferably, the silver foam 45 is contained in a permeable housing(not shown) which has a plurality of water holes. In case that the silver foam 45 is contained in the permeable housing, the silver foam 45 is protected by the housing and the life span of the silver foam 45 may be prolonged more so that the user may use the invention more conveniently and the management cost may be saved more.

Meanwhile, when the silver is in an ionized state, it may kill colitis germs only with extremely small amount like as about several ten ppb. The term ‘ppb’ is the initials of ‘parts per billion’, and it is a unit related to density and means one billionth.

Silver solution of 1 ppb means that silver of 1 g is resolved in the water contained in a cubic water tank one side of which is 10M. Accordingly, it is thought that even small amount of silver may do sufficient effect. And, the silver antibiotics may do antibiotic effect on a variety of bacteria.

Like the above, because silver is a metal which may do high antibiotic effect and is so safe, it may be used as main substance of antibiotics. Here, the main substance of antibiotics is inorganic antibiotics. The antibiotic substance of the inorganic antibiotics is a metal. There is Hg and the like among the metals having antibiotic effect. However for the sake of safety, Ag, Cu and Zn have ben used for the inorganic antibiotics Particularly, because Ag may do high antibiotic effect and it is so safe in use, the silver may be the main substance of the inorganic antibiotics. Recently, silver antibiotics has become the main antibiotics among the various inorganic antibiotics.

Accordingly, the shower head 30 has an advantage that a porous silver foam 45 is positioned in the water passage 10 and harmful bacteria may be sterilized by the silver foam 45 so that the harmful bacteria may not be directly contacted to the skin of the user and various skin trouble like itching symptom or allergy and so on may be prevented.

Particularly, because the silver foam 45 is formed with a porous block type which has a plurality of pores 47 and the water passes through the pores 47 and silver will be effectively dissolved in the water, the contact area between the silver and the harmful bacteria or a variety of harmful alien material may be increased maximally. Accordingly, Ag ion may be effectively dissolved in the water by the silver foam 45 and the harmful bacteria or the alien material may be killed as much as possible so that the sterilization effect may be maximized.

And, the life span of the silver foam 30 is semi-permanent and need not to be replaced frequently so that a user may use the invention so conveniently and the management cost may be save remarkably.

Further, as shown in FIG. 2, the water passage 10 of the head 30 may be divided in a first and a second passages 12a, 12b by a permeable wall 8a, and the silver foam 45 is positioned in the first water passage 12a and a plurality of ceramic balls 50 may be positioned in the second water passage 12b. The ceramic balls 50 has sterilization function and radiates far infrared rays so that the synergy effect may be expected as the sterilization effect may be increased more.

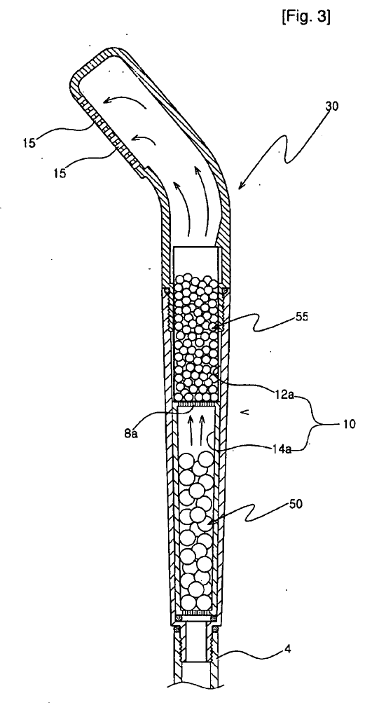

Further, FIG. 3 is a sectional view of another embodiment of the invention. Referring to FIG. 3, the silver balls 55 may be filled in the water passage 10 of the head 30 and the water passing though the water passage 10 may be sterilized by the silver balls 55.

### INDUSTRIAL APPLICABILITY

According to the above described invention, the shower head has an advantage that the water harmful bacteria may be sterilized by a porous silver foam and the harmful bacteria may not be contacted to the skin of the user so that skin troubles like itching symptom may not be caused owing to the harmful bacteria. And, the invention is so convenient in use because there is no need replacing the silver foam periodically until the life span of the apparatus using the silver foam has been expired and the management cost may be saved remarkably.

1. A shower head 30 which has water passage 10 therein and has a plurality of holes 15 at its front end and the base end of which is connected to a water line 4;
wherein a porous silver foam 45 is positioned in the water passage 10;
and wherein the water passing through the water passage 10 may be sterilized by the silver foam 45.

2. A shower head 30 which has water passage 10 therein and has a plurality of holes 15 at its front end and the base end of which is connected to a water Line 4;
wherein a silver balls 55 is positioned in the water passage 10;
and wherein the water passing though the water passage 10 may be sterilized by the silver balls 55.
